(19) United States
(12) Patent Application Publication
(10) Pub. No.: US 2015/0022502 A1
(43) Pub. Date: Jan. 22, 2015

(54) METHOD FOR READING OUT A LIGHT SENSOR CONTROL UNIT AND A DEVICE FOR READING OUT A LIGHT SENSOR CONTROL UNIT

(71) Applicants: Frank Fischer, Gomaringen (DE); David Slogsnat, Tuebingen (DE)

(72) Inventors: Frank Fischer, Gomaringen (DE); David Slogsnat, Tuebingen (DE)

(73) Assignee: ROBERT BOSCH GMBH, Stuttgart (DE)

(21) Appl. No.: 14/377,889

(22) PCT Filed: Feb. 4, 2013
(86) PCT No.: PCT/EP2013/052176

§ 371 Date: Aug. 11, 2014

(30) Foreign Application Priority Data
Feb. 10, 2012 (DE) 10 2012 201 978.2

(51) Int. Cl. G06F 3/042; G06F 3/01

(52) U.S. Cl. CPC G06F 3/0421; G06F 3/017
USPC 345/175

(57) ABSTRACT

A method for reading out a light sensor control unit having the method steps: (a) reading out a light signal of the light sensor by the light sensor control unit and generating a data signal corresponding to the light signal, b) storing the generated data signal in a buffer memory unit of the light sensor control unit and, if a terminating condition is not fulfilled: continuing the method with method step a), if the terminating condition is fulfilled: continuing the method with c) reading out the data signals stored in the buffer memory unit of the light sensor control unit in a data block by a processor device.

### FIELD

The present invention relates to a method for reading out a light sensor control unit and a device for reading out a light sensor control unit

### BACKGROUND INFORMATION

German Patent Application No. DE 196 00 195 C2 describes an image signal processing device and a method for processing digital data signals for output of an image signal.

The image signal processing device described therein for processing a first digital data signal having a predetermined first data format and a second digital data signal having a second predetermined data signal differing from the first data format includes: an input circuit on which the first and second digital data signals having the two different, predetermined data formats are present, and a processing circuit assigned to the input circuit, in which the first and second digital data signals are provided with a format value characterizing the type of the assigned data format or are changed, an image memory coupled to the processing circuit, in which the first and second digital data signals provided with the format value or changed, are stored at least temporarily.

Furthermore, the image signal processing device described includes a coordination circuit assigned to the image memory, in which the at least temporarily stored first and second digital data signals of different data formats, which are provided with the format value or are changed, are read in from the image memory chronologically in succession, the coordination circuit carrying out a conversion of at least one data format of the first and/or second digital data signals into an image format as a function of the format value characterizing the type of the assigned data format of the digital data signals.

FIG. 4 shows a schematic diagram of an exemplary data stream for explaining an exemplary method for data transmission.

A plurality of data frames F1 through Fn is shown in FIG. 4. For data transmission, data signals DP1 through DPn are in each case formed from data frames F1 through Fn in the form of individual data blocks RO1 through ROn. Individual data blocks RO1 through ROn are defined by a limited number of bits or bytes established on a case-by-case basis and are treated as a transport unit. The block structure and the block elements of individual data blocks RO1 through ROn conform to the relevant communication protocols.

In the case of the exemplary method, one individual data block ROi is formed per data signal DPi, which encodes a certain data frame Fi.

### SUMMARY

The present invention provides a method and a device for reading out a light sensor control unit.

In accordance with the present invention, a method for reading out a light sensor control unit is provided including: (a) reading out a light signal of the light sensor by the light sensor control unit and generating a data signal corresponding to the light signal, b) storing the generated data signal in a buffer memory unit of the light sensor control unit and, if a terminating condition is not fulfilled: continuing the method with method step a), if the terminating condition is fulfilled: continuing the method with: c) reading out the data signals stored in the buffer memory unit of the light sensor control unit in a data block by a processor device.

In accordance with the present invention, a buffer memory is used when reading out a light sensor control unit using an application processor, the buffer memory avoiding time-consuming multiple accesses and data transmissions from the light sensor control unit to the application processor.

For this purpose, the data signals generated by the light sensor control unit are buffered in order to be collected, and the stored data signals are transmitted with the aid of a data block including all generated data signals.

This advantageously makes it possible to increase the maximum possible data transmission rate and provide relief for the application processor.

According to one specific embodiment of the present invention, the terminating condition used in method step b) is adapted to a memory capacity of the buffer memory unit of the light sensor control unit and/or to a memory size of the data signal corresponding to the light signal and/or to a number of the data signals to be stored in the buffer memory unit of the light sensor control unit.

According to another specific embodiment of the present invention, the terminating condition used in method step b) includes an iterator which may be incremented from an initial number to a final number.

According to another specific embodiment of the present invention, the initial number and the final number of the incrementable iterator are determined by the processor device.

According to another specific embodiment of the present invention, an interrupt signal is sent to the processor device when the final number is reached.

According to another specific embodiment of the present invention, if no memory space is present in the buffer memory unit in method step b) when the generated data signal is stored due to an absence of the read-out of the data signals stored in the buffer memory unit of the light sensor control unit, the most recently generated data signal replaces a previous data signal for storing the generated data signal in method step b).

According to another specific embodiment of the present invention, if no memory space is present in the buffer memory unit in method step b) when the generated data signal is stored due to an absence of the read-out of the data signals stored in the buffer memory unit of the light sensor control unit, the most recently generated data signal is not stored in method step b).

According to another specific embodiment of the present invention, the terminating condition used in method step b) is adapted to a characteristic of the data signal.

According to another specific embodiment of the present invention, a characteristic with respect to the light signal of the light sensor, which is stored in the data signal, is used as a characteristic of the data signal.

Additional features and advantages of specific embodiments of the present invention ensue from the following description with reference to the figures.

The described embodiments and refinements may, if practical, be arbitrarily combined with one another. Additional possible embodiments, refinements and implementations of the present invention also include non-explicitly named combinations of features of the present invention, which were previously described or are described in the following with regard to the exemplary embodiments.

The figures are intended to convey a further understanding of the specific embodiments of the present invention. They illustrate specific embodiments and are used in combination with the description for explaining principles of the present invention. Other specific embodiments and many of the above-named advantages result with respect to the figures. The elements of the figures are not necessarily shown true to scale in relation to one another.

### BRIEF DESCRIPTION OF THE DRAWINGS

FIG. 1 shows a schematic diagram of a flow chart of a method for reading out a light sensor control unit according to a first specific embodiment of the present invention.

FIG. 2 shows a schematic diagram of a device for reading out a light sensor control unit according to a second specific embodiment of the present invention.

FIG. 3 shows a schematic diagram of a data stream in the form of a data block according to a third specific embodiment of the present invention.

FIG. 4 shows a schematic diagram of an exemplary data stream for explaining an exemplary method for data transmission.

### DETAILED DESCRIPTION OF EXAMPLE EMBODIMENTS

Identical reference numerals in the figures denote identical components or components having an identical function.

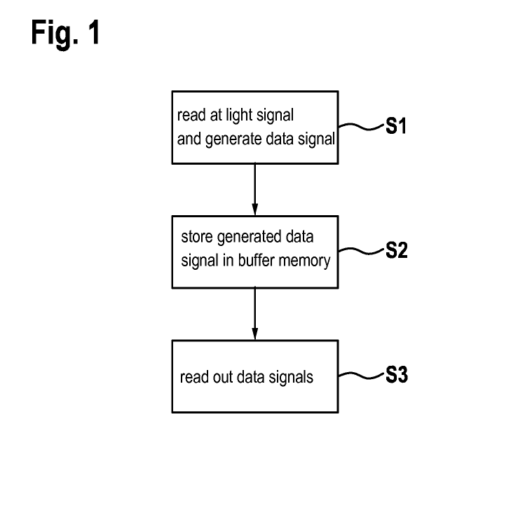

FIG. 1 shows a schematic diagram of a flow chart of a method for reading out a light sensor control unit according to a first specific embodiment of the present invention.

In a first method step a) of the method, a light signal of the light sensor is read out S1 by a light sensor control unit 2 and a data signal DPi corresponding to the light signal is generated.

In a second method step b) of the method, generated data signal DPi is stored S2 in a buffer memory unit 12 of light sensor control unit 2 and, if a terminating condition is not fulfilled, the method is continued with method step a).

If, however, the terminating condition is fulfilled, the method is continued with a third method step c), data signals DP1 through DPn stored in buffer memory unit 12 of light sensor control unit 2 being read out S3 in a data block ROA1 by a processor device 1.

Buffer memory unit 12 may, for example, also be read out only partially. In particular, buffer memory unit 12 may also be read out using multiple data blocks ROA1.

For example, the terminating condition includes an incrementable iterator from an initial number to a final number, causing method steps a) and b) to pass through a loop.

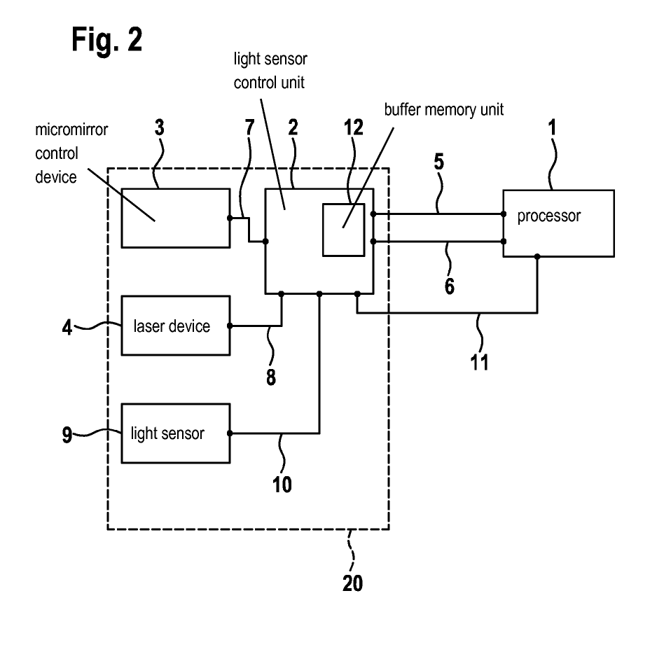

FIG. 2 shows a schematic diagram of a device for reading out a light sensor control unit according to a second specific embodiment of the present invention.

A processor device 1 is, for example, connected to a light sensor control unit 2 via an interrupt line 11, a video data line 5 and a control data line 6.

A projector device 20 includes, for example, light sensor control unit 2, a micro-mirror control unit 3, a laser device 4 and a light sensor 9.

Micro-mirror control unit 3 is connected to light sensor control unit 2 via a first interface line 7. Laser device 4 is connected to light sensor control unit 2 via a second interface line 8. Light sensor 9 is connected to light sensor control unit 2 via a third interface line 10.

For example, control commands for reading out data signals DP1 through DPn in a buffer memory unit 12 are provided via control data line 6 with the aid of a single data block ROA1.

Light sensor 9 now delivers, for example, data of a person located in front of projector device 20 who makes gestures in interaction with the images projected by projector device 20.

In this case, the data delivered by light sensor 9 are formed, for example, in the form of image data having different frames F1 through Fn. This is, for example, provided in the case of the design of light sensor 9 in the form of an optical camera.

Light sensor 9 may, however, also be made up of a photosensor, a photodiode or another optoelectronic sensor or of a plurality of photosensors, photodiodes or other optoelectronic sensors.

Processor device 1 is, for example, designed for gesture recognition. In this case, an algorithm is stored in processor device 1 for the automatic recognition of gestures made by persons. The data of light sensor 9 make it possible to recognize gestures.

Processor device 1 thus achieves a utilization of recognized gestures for human-computer interaction. Every posture and body movement may in principle represent a gesture to be recognized by the processor device. Also possible is recognition of hand or head gestures of the person or an interaction of the person with graphic information in the form of switch fields, buttons or other virtually projected input fields displayed by projection device 20. The gesture recognition carried out by processor device 1 makes it possible to analyze data signals DP1 through DPn delivered by light sensor 9.

For example, data signals DP1 through DPn stored in buffer memory unit 12 of light sensor control unit 2 are read out in a data block ROA1 by a processor device 1 via video data line 5, after the control signals necessary for this purpose have been transmitted from processor device 1 to light sensor control unit 2 via control data line 6.

For example, the read-out takes place after a request for carrying out gesture recognition is sent to processor device 1. Furthermore, the read-out of stored data signals DP1 through DPn may be controlled by a terminating condition.

If no read-out takes place, different bypass methods may be applied for the case that buffer memory unit 12 has no memory space for storing data signals DPi.

In the case of a bypass method, those data signals DPi-x having an older priority, which were stored first, are left in buffer memory unit 12. Here, data signals DPi, which are newly detected by light sensor 9, are discarded and not stored in buffer memory unit 12.

In an opposite bypass method, data signals DPi-x having an older priority are overwritten using more recent data signals DPi of light sensor 9. Thus in the case of this method, data signals DPi concerning the most recently measured light signals of light sensor 9 are continuously present in buffer memory unit 12.

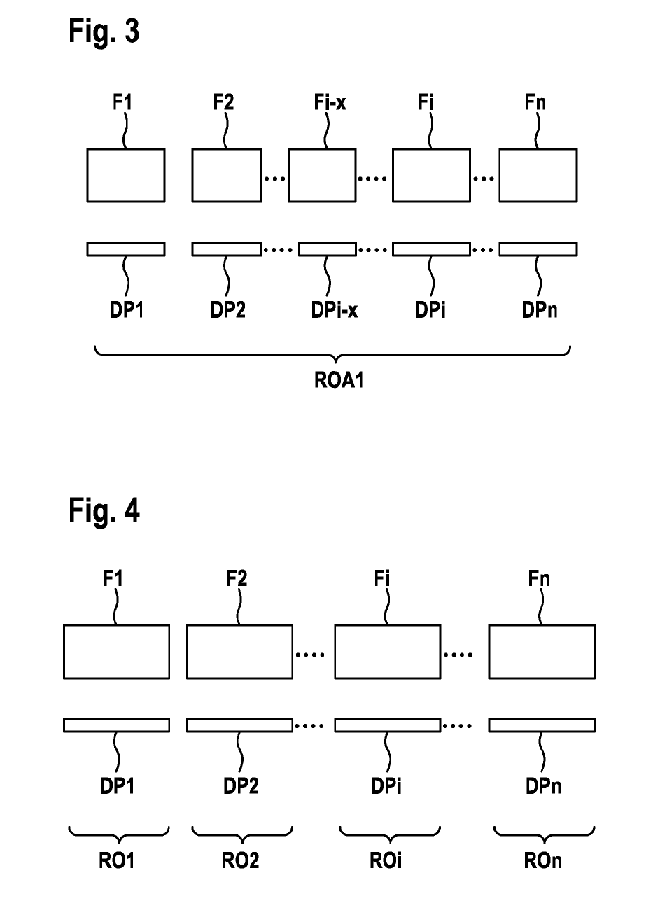

FIG. 3 shows a schematic diagram of a data stream in the form of a data block according to a third specific embodiment of the present invention.

A plurality of data frames F1 through Fn are shown in FIG. 3. Here, data signals DP1 through DPn are in each case formed from data frames F1 through Fn. For transmission of data signals DP1 through DPn, a data block ROA1 is formed from the plurality of data signals DP1 through DPn.

Data block ROA1 is, with respect to its size, defined by a limited number of bits or bytes established on a case-by-case basis and is treated as a transport unit. The block structure and the block elements of data block ROA1 conform to the relevant communication protocols. In the present case, a data block ROA1 is formed which includes a plurality of data signals DPi, each of which encodes a certain frame Fi of the data of light sensor 9. Data signals DP1-x having an older priority accordingly encode a frame Fi-x of the data of light sensor 9 having an older priority.

Although the present invention has been described based on multiple exemplary embodiments, which may be combined arbitrarily with one another, it is not limited to them, but instead may be further modified in a variety of ways.

1-10. (canceled)

11. A method for reading out a light sensor control unit, comprising:
a) detecting a light signal of a light sensor by the light sensor control unit and generating a data signal corresponding to the light signal;
b) storing the generated data signal in a buffer memory unit of the light sensor control unit and, if a predefinable terminating condition is not fulfilled:
continuing the method with step a),
if the predefinable terminating condition is fulfilled:
continuing the method with:
c) reading out the data signals stored in the buffer memory unit of the light sensor control unit in a data block by a processor device.

12. The method as recited in claim 11, wherein the terminating condition used in step b) is adapted to at least one of: i) a memory capacity of the buffer memory unit of the light sensor control unit, ii) to a memory size of the data signal corresponding to the light signal, and iii) to a number of the data signals to be stored in the buffer memory unit of the light sensor control unit.

13. The method as recited in claim 11, wherein the terminating condition used in step b) includes using an iterator which may be incremented from an initial number to a final number.

14. The method as recited in claim 13, wherein the initial number and the final number of the incrementable iterator are determined by the processor device.

15. The method as recited in claim 13, wherein an interrupt signal is sent to the processor device when the final number is reached.

16. The method as recited in claim 11, wherein, if no memory space is present in the buffer memory unit in step b) when the generated data signal is stored due to an absence of the read-out of the data signals stored in the buffer memory unit of the light sensor control unit, a most recently generated data signal replaces a previous data signal for storing the generated data signal in step b).

17. The method as recited in claim 11, wherein, if no memory space is present in the buffer memory unit in step b) when the generated data signal is stored due to an absence of the read-out of the data signals stored in the buffer memory unit of the light sensor control unit, a most recently generated data signal is not stored in step b).

18. The method as recited in claim 11, wherein the terminating condition used in step b) is adapted to a characteristic of the data signal.

19. The method as recited in claim 18, wherein a characteristic with respect to the light signal of the light sensor, which is stored in the data signal, is used as a characteristic of the data signal.

20. A device for reading out a light sensor, the device configured to a) detect a light signal of a light sensor by the light sensor control unit and generating a data signal corresponding to the light signal, b) store the generated data signal in a buffer memory unit of the light sensor control unit and, the device configured to, if a predefinable terminating condition is not fulfilled: continue with a), and if the predefinable terminating condition is fulfilled: continue with c) read out the data signals stored in the buffer memory unit of the light sensor control unit in a data block by a processor device.
